(19) United States
(12) Patent Application Publication
(10) Pub. No.: US 2014/0140373 A1
(43) Pub. Date: May 22, 2014

(54) APPARATUS AND METHOD OF TESTING SEMICONDUCTOR MODULE

(71) Applicant: c/o SAMSUNG ELECTRO-MECHANICS CO., LTD, Suwon (KR)

(72) Inventors: Shang Hoon Seo, Suwon (KR); Seung Hwan Kim, Suwon (KR); Suk Jin Ham, Suwon (KR)

(73) Assignee: c/o SAMSUNG ELECTRO-MECHANICS CO., LTD, Suwon (KR)

(21) Appl. No.: 14/022,893

(22) Filed: Sep. 10, 2013

(30) Foreign Application Priority Data
Nov. 22, 2012 (KR) 10-2012-0132968

(51) Int. Cl. G01K 7/01

(52) U.S. Cl. CPC G01K 7/01
USPC 374/178

(57) ABSTRACT

There are provided an apparatus and a method of testing a semiconductor module capable of easily testing a power semiconductor module including a plurality of switching devices. The apparatus for testing a semiconductor module includes: a main substrate disposed within a case; a jig substrate detachably coupled to the main substrate; and a socket substrate detachably coupled to the jig substrate and having the semiconductor module mounted thereon.

### CROSS-REFERENCE TO RELATED APPLICATIONS

This application claims the benefit of Korean Patent Application No. 10-2012-0132968 filed on Nov. 22, 2012, with the Korean Intellectual Property Office, the disclosure of which is incorporated herein by reference.

### BACKGROUND OF THE INVENTION

1. Field of the Invention

The present invention relates to an apparatus and method of testing a semiconductor module, and more particularly, to an apparatus and method of testing a semiconductor module allowing a power semiconductor module, including a plurality of switching devices, to be easily tested.

2. Description of the Related Art

In accordance with the development the field of electronics, the use of power devices such as power transistors, insulated-gate bipolar transistors (IGBT), metal oxide semiconductor (MOS) transistors, silicon-controlled rectifiers (SCR), power rectifiers, servo drivers, power regulators, inverters, converters, and the like has increased, as well as demand for power products having excellent performance which are capable of being thinned and miniaturized.

In accordance with this trend, research into a technology for integrating various power semiconductor devices in a single package and manufacturing the power semiconductor devices and a control device for controlling the power semiconductor devices in the single package has been recently conducted actively.

Recently, a power semiconductor module including a plurality of switching devices has been developed and used.

The power semiconductor module is operated by allowing the plurality of switching devices to repeatedly perform an on/off switching operation. However, in the case of a power semiconductor module for industry, since power consumption is large and individual components have a large size, a temperature change has been highlighted as an important element as compared with an existing low power semiconductor.

Particularly, since heat generation and cooling frequently occur due to the repeated on/off switching operation of the switching devices, thermal stress is generated due to a difference in coefficients of thermal expansion (CTE) between internal components, such that a fault such as delamination, cracking, or the like, may be generated in a product.

Therefore, in order to solve this problem, a test apparatus for measuring heat generation of a power semiconductor module including a plurality of switching devices and quantifying a stress level is in demand.

### RELATED ART DOCUMENT

(Patent Document 1) Korean Patent Laid-Open Publication No. 2006-0011047

### SUMMARY OF THE INVENTION

An aspect of the present invention provides an apparatus for testing a semiconductor module capable of easily measuring heat generation of a power semiconductor module including a plurality of switching devices.

An aspect of the present invention also provides a method of testing a semiconductor module by measuring heat generation of a power semiconductor module including a plurality of switching devices.

According to an aspect of the present invention, there is provided an apparatus for testing a semiconductor module including: a main substrate disposed within a case; a jig substrate detachably coupled to the main substrate; and a socket substrate detachably coupled to the jig substrate and having the semiconductor module mounted thereon.

The main substrate and the jig substrate may be electrically and physically coupled to each other by connector coupling.

The jig substrate and the socket substrate may be electrically and physically coupled to each other by connector coupling.

The semiconductor module may be soldered to and mounted on the socket substrate by a conductive solder.

The jig substrate may be coupled to the main substrate so as to be perpendicular to the main substrate.

The apparatus for testing a semiconductor module of may further include a cooling part disposed within the case and cooling the semiconductor module.

The apparatus for testing a semiconductor module may further include a temperature measuring part coupled to the semiconductor module and sensing a temperature change in the semiconductor module.

The apparatus for testing a semiconductor module may further include a controlling part electrically connected to the main substrate and the temperature measuring part, selectively applying power to the semiconductor module through the main substrate, and measuring the temperature change of the semiconductor module through the temperature measuring part.

The temperature measuring part may include: a fixing jig coupled to an outer surface of the semiconductor module while contacting the outer surface of the semiconductor module; and at least one temperature sensor coupled to the fixing jig and sensing a temperature of the semiconductor module.

The fixing jig may have an insertion groove formed in one surface thereof contacting the semiconductor module, and the temperature sensor may be inserted into the insertion groove to contact the outer surface of the semiconductor module.

The semiconductor module may include a plurality of switching devices, and a plurality of temperature sensors may be disposed in positions corresponding to those of the switching devices, respectively.

The semiconductor module may include six switching devices, and three temperature sensors may be disposed in positions corresponding to spaces between the switching devices.

According to another aspect of the present invention, there is provided a method of testing a semiconductor module including: mounting a semiconductor module on a socket substrate; coupling the socket substrate to a jig substrate; coupling the jig substrate to a main substrate disposed within a case; and testing the semiconductor module by applying a voltage to the semiconductor module.

The coupling of the jig substrate to the main substrate may include coupling the jig substrate to the main substrate so as to be perpendicular to the main substrate.

The method of testing a semiconductor module may further include, before the mounting of the semiconductor module on the socket substrate, coupling a temperature measuring part to the semiconductor module.

The testing of the semiconductor module may include measuring a change of state in the semiconductor module according to a change in the applied voltage.

The testing of the semiconductor module may include: estimating surface temperatures corresponding to junction temperatures of switching devices provided in the semiconductor module; and applying the voltage to the semiconductor module based on the estimated surface temperatures.

The estimating of the surface temperatures may include: measuring temperatures using a plurality of temperature sensors disposed in the semiconductor module so as to be spaced apart from each other; and estimating the surface temperatures of the semiconductor modules using an average value of the measured temperature values.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a front view schematically illustrating an apparatus for testing a power semiconductor module according to an embodiment of the present invention;

FIG. 2 is an exploded perspective view of FIG. 1;

FIGS. 3A and 3B are perspective views schematically illustrating a power semiconductor module and a temperature measuring part according to the embodiment of the present invention;

FIG. 3C is a plan view schematically illustrating the power semiconductor module of FIG. 3A; and

FIG. 4 is a circuit diagram schematically illustrating a circuit of a relay module according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

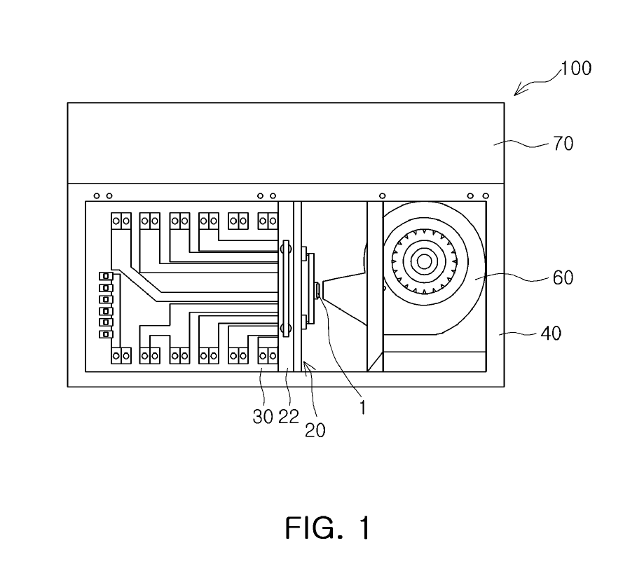

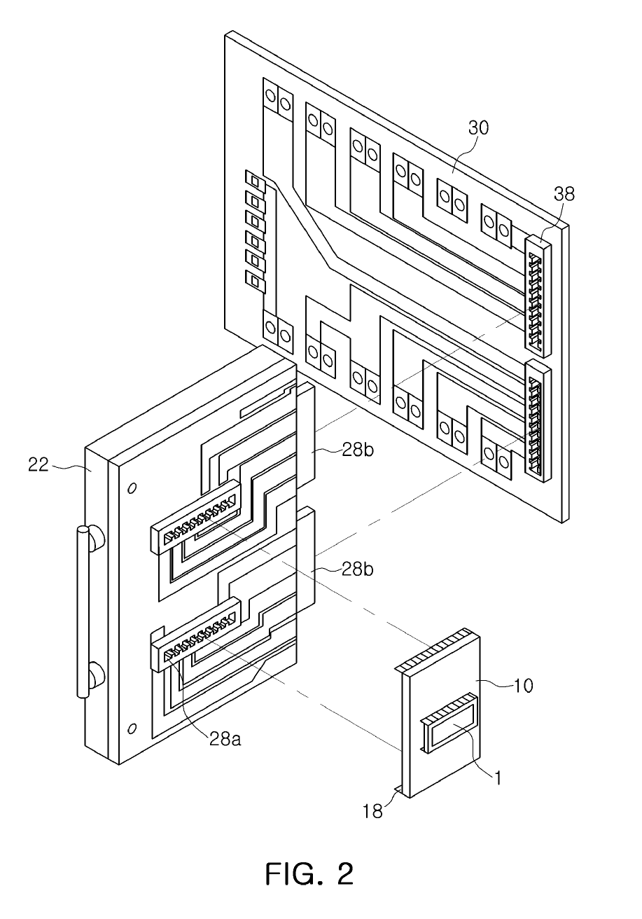

FIG. 1 is a front view schematically illustrating an apparatus for testing a power semiconductor module according to an embodiment of the present invention; and FIG. 2 is an exploded perspective view of FIG. 1, Here, in FIG. 2, a case and a cooling part of FIG. 1 have been omitted.

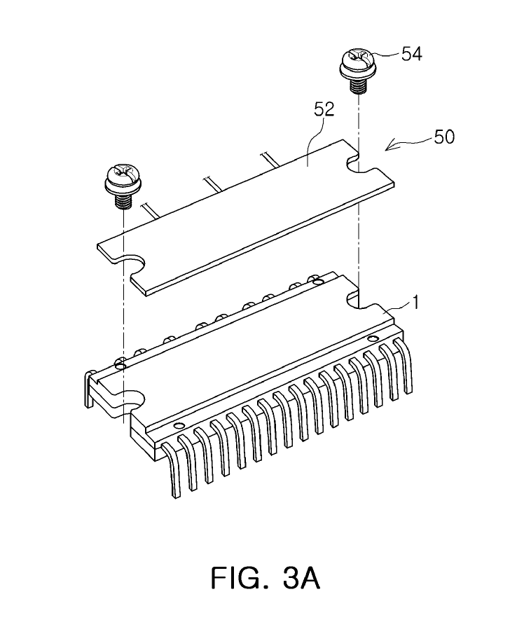

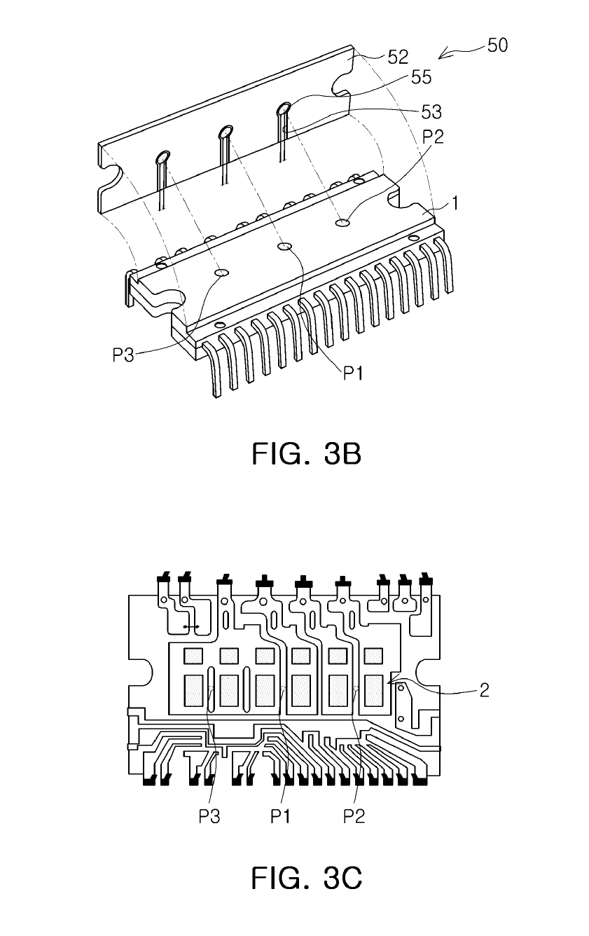

FIGS. 3A and 3B are perspective views schematically illustrating a temperature measuring part according to the embodiment of the present invention; wherein FIG. 3A shows an upper portion of the temperature measuring part; and FIG. 3B shows a lower portion of the temperature measuring part. In addition, FIG. 3C is a plan view schematically illustrating the power semiconductor module of FIG. 3A. In FIG. 3, a plan view in which a molding part is omitted in the power semiconductor module is shown.

Referring to FIGS. 1 through 3C, the apparatus 100 for testing a power semiconductor module according to the present embodiment, which is an apparatus for testing a power semiconductor module 1 including a plurality of switching devices 2, may include a socket substrate 10, a jig substrate 20, a main substrate 30, a cooling part 60, a case 40, a temperature measuring part 50, and a controlling part 70.

Here, the power semiconductor module 1 may include a switching device for power conversion for controlling power or power control, such as a servo driver, an inverter, a power regulator, a converter, and the like.

For example, the switching device 2 may include a power metal oxide semiconductor field effect transistor (MOSFET), a bipolar junction transistor (BJT), an insulated gated bipolar transistor (IGBT), a diode, or a combination thereof. That is, in the present embodiment, the power semiconductor device may include all of or some of the above-mentioned devices.

In addition, two switching devices shown in FIG. 3C may be an insulated gate bipolar transistor (IGBT) and a diode, respectively. In addition, a total of six pairs of power semiconductor device packages may be implemented, wherein each pair includes the insulated gate bipolar transistor (IGBT) and the diode. However, this is only an example, and the present invention is not necessarily limited thereto.

The socket substrate 10 may be a substrate on which the power semiconductor module 1 corresponding to a test target is mounted. Therefore, the socket substrate 10 may have a size corresponding to that of the power semiconductor module 1.

The power semiconductor module 1 may be mounted on the socket substrate 10 by performing soldering using a conductive solder, or the like. The power semiconductor module 1 is mounted on the socket substrate 10 by the soldering to allow contact resistance to be decreased as compared with the case of using a connector, such that a product may be tested at a high current and with a amount of heat generation in the switching device may be more accurately measured. However, the present invention is not limited thereto.

The socket substrate 10 may include a first connector 18 so as to be coupled to a jig substrate 20 to be described below.

The jig substrate 20 may have the socket substrate 10 coupled thereto. To this end, the jig substrate 20 may include a second connector 28a formed on one surface thereof so that the socket substrate 10 may be easily coupled physically and electrically thereto.

As the jig substrate 20, various substrates having wiring patterns may be used. In addition, in order to reinforce rigidity of the jig substrate 20, the jig substrate 20 may have a reinforcing plate 22 fastened to the other surface thereof. The reinforcing plate 22 may be formed of a flat plate having rigidity, for example, a metal plate.

In addition, the jig substrate 20 may include a third connector 28b so as to be physically and electrically connected to a main substrate 30 to be described below.

The jig substrate 20 according to the present embodiment may be coupled to the main substrate 30 in a direction perpendicular to that of the main substrate 30. Therefore, the third connector 28b may be disposed on a side of the jig substrate 20 and be coupled to a fourth connector 38 of the main substrate 30.

Particularly, the jig substrate 20 may be detachably coupled to the main substrate 30 though the third connector 28b. Therefore, after a plurality of jig substrates 20 having various power semiconductor modules 1 mounted thereon are prepared, the jig substrates 20 may be selectively coupled to the main substrate 30 to perform a test.

The main substrate 30 may be disposed within a case 40 to be described below and have the jig substrate 20 connected thereto to thereby be electrically connected to the power semiconductor module 1 through the jig substrate 20. The main substrate 30 may be disposed approximately in parallel with a rear surface of the case 40 so that the jig substrate 20 is easily detachable from a front surface of the case 40. In addition, the main substrate 30 may include the fourth connector 38 connected to the third connector 28b of the jig substrate 20.

Meanwhile, as the socket substrate 10, the jig substrate 20, and the main substrate 30 according to the present embodiment, a printed circuit board (PCB) may be used. However, the present invention is not limited thereto. That is, various types of substrates such as a ceramic substrate, a glass substrate, a silicon substrate, a pre-molded substrate, a direct bonded copper (DBC) substrate, an insulated metal substrate (IMS), and the like, may be selectively used if necessary.

The cooling part 60 may be disposed in a position corresponding to that of the power semiconductor module 1. That is, the cooling part 60 may provide a refrigerant to the position of the power semiconductor module 1 in a state in which the jig substrate 20 having the socket substrate 10 coupled thereto is coupled to the main substrate 30. The cooling part 60 according to the present embodiment may be configured in an air cooling type. To this end, the cooling part 60 according to the present embodiment may include a cooling fan. Therefore, air may be used as the refrigerant. However, the present invention is not limited thereto. That is, various types of coolers may be used if necessary. For example, the cooling part 60 may be configured in a water cooling type.

The case 40 may provide an accommodating space in which the above-mentioned components may be accommodated and protect the above-mentioned components from external impact, or the like. Therefore, the case 40 may be formed of various materials capable of having rigidity enough to endure the external impact and capable of firmly coupling the main substrate 30 or the cooling part 60 thereto.

In addition, the case 40 may be formed in a shape in which a front surface thereof is opened so that the jig substrate 20 is easily detachable from the main substrate 30.

The temperature measuring part 50 may be fastened to the power semiconductor module 1 and measure a temperature of the power semiconductor module 1. As shown in FIGS. 3A and 3B, the temperature measuring part 50 according to the present embodiment may include a fixing jig 52, a temperature sensor 55, and a fixing screw 54.

The fixing jig 52 may be fastened to an outer surface of the power semiconductor module 1. Here, the fixing jig 52 may be fastened by the fixing screw 54. In addition, the fixing jig 52 may have at least one fixing groove 53 formed in an inner portion, that is, a lower surface, thereof, wherein the fixing groove 53 have the temperature sensor 55 disposed therein.

The temperature sensor 55 may be disposed in the fixing groove 53 formed in the fixing jig 52. Therefore, when the fixing jig 52 is coupled to the power semiconductor module 1, the temperature sensor 55 may contact or be disposed to be very adjacent to an outer surface of the power semiconductor module 1 to sense heat transferred from the power semiconductor module 1.

The power semiconductor module 1 according to the present embodiment may include six switching devices 2 as shown in FIG. 3C. Therefore, in order to detect temperatures of the respective switching devices 2, it is preferable that six temperature sensors 55 are provided. However, in this case, the temperature sensors 55 may be excessively densely disposed according to a size of the power semiconductor module 1.

Therefore, the case in which only three temperature sensors 55 are used will be described by way of example in the present embodiment.

In this case, it is preferable that the three temperature sensors 55 are disposed between the switching devices 2, respectively. More specifically, as shown in FIG. 3C, one of the three temperature sensors 55 may be disposed in the center P1 of the six switching devices 2 disposed in parallel with each other and the other two of the three temperature sensors 55 may be disposed in positions P2 and P3 symmetrical to each other based on the center P1. In addition, the two temperature sensors 55 adjacent to each other may be configured so that two switching devices are disposed therebetween.

In the case in which the temperature sensors 55 are disposed as described above, temperatures of the six switching devices 2 may be easily measured only using the three temperature sensors 55.

As the temperature sensor 55, a thermo-couple temperature sensor 55 may be used. However, the present invention is not limited thereto.

The temperature measuring part 50 configured as described above may be electrically connected to a controlling part 70 to be described below and transfer temperature change information or state information of the power semiconductor module 1 to the controlling part 70. The case in which the temperature measuring part 50 is connected to the controlling part 70 through a separate wire has been described by way of example in the present embodiment. However, the present invention is not limited thereto, but may be variously applied if necessary. For example, the temperature measuring part 50 may be electrically connected to the controlling part 70 using wiring patterns formed on the socket substrate 10, the jig substrate 20, the main substrate 30, and the like.

The controlling part 70 may be electrically connected to the main substrate 30 to apply various signals to the power semiconductor module 1 through the main substrate 30. Although the case in which the controlling part is disposed in an upper portion of the case has been shown in FIG. 1, the present invention is not limited thereto, but may be variously applied. That is, the controlling part may be disposed in a lower portion of the case or be disposed in each of the upper and lower portions of the case and may be disposed separately from the case and be electrically connected to the case.

The controlling part 70 may include at least one relay module. The relay module may be provided in order to selectively drive the switching devices 2 of the power semiconductor module 1.

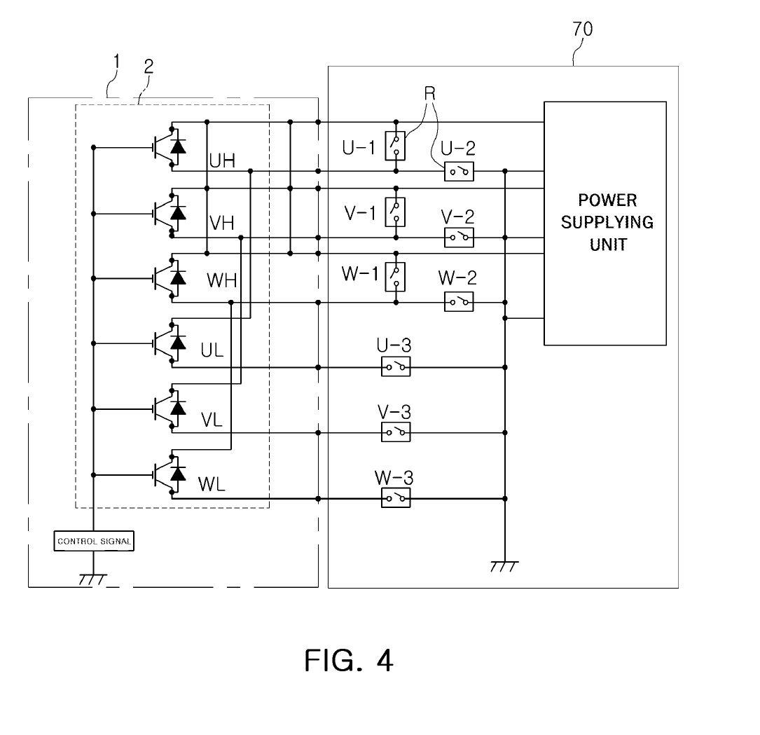

FIG. 4 is a circuit diagram schematically illustrating a circuit of a relay module according to the embodiment of the present invention. Referring to FIG. 4, the relay module according to the present embodiment may include a plurality of relays R in order to selective drive the plurality of switching devices.

The power semiconductor module 1 according to the present embodiment may be a power semiconductor module for controlling a three-phase motor. To this end, the power semiconductor module 1 may include six switching devices 2, that is, high and low switching devices for each of the U, V, and W phases.

Therefore, in order to test the power semiconductor module 1 as described above, the test needs to be independently or simultaneously performed on the six switching devices 2. Alternatively, the test needs to be performed on three pairs of high and low devices U-HL, V-HL, W-HL corresponding to each phase or needs to be performed on three high devices UVW-H and three low devices UVW-L.

To this end, the controlling part 70 according to the present embodiment may selectively apply power to the power semiconductor module 1 using the relays R as switches to perform the test.

Whether the relay has been opened or closed for the test may be recognized through the following Table 1.

TABLE 1

| Number of | | | | | | | | | | |
|---|---|---|---|---|---|---|---|---|---|---|
| switching | | | | | | | | | | |
| device | Division | U-1 | U-2 | U-3 | V-1 | V-2 | V-3 | W-1 | W-2 | W-3 |
| one | U-H | open | close | open | open | open | open | open | open | open |
| | V-H | open | open | open | open | close | open | open | open | open |
| | W-H | open | open | open | open | open | open | open | close | open |
| | U-L | close | open | close | open | open | open | open | open | open |
| | V-L | open | open | open | close | open | close | open | open | open |
| | W-L | open | open | open | open | open | open | close | open | close |
| two | U-HL | open | open | close | open | open | open | open | open | open |
| | V-HL | open | open | open | open | open | close | open | open | open |
| | W-HL | open | open | open | open | open | open | open | open | close |
| three | UVW-H | open | close | open | open | close | open | open | close | open |
| | UVW-L | close | open | close | close | open | close | close | open | close |
| six | UVW-HL | open | open | close | open | open | close | open | open | close |

For example, in the case in which the test is performed on all of the six switching devices, only three relays U-3, V-3, and W-3 are closed and all of the other relays are opened.

The apparatus 100 for testing a power semiconductor module according to the present embodiment configured as described above may simultaneously or independently test the six switching devices 2 in the power semiconductor module 1. In addition, the jig substrate 20 and the socket substrate 10 may be configured to be detachable from the main substrate 30. Therefore, after several kinds of power semiconductor modules 1 are coupled to the socket substrate 10 and the jig substrate 20, the test may be performed while only replacing the jig substrate 20. As a result, the test may be easily performed.

Next, a method of testing a power semiconductor module 1 using the apparatus 100 for testing a power semiconductor module according to the present embodiment will be described.

In the method of testing a power semiconductor module according to the present embodiment, the temperature measuring part 50 is first fastened to the power semiconductor module 1 as shown in FIG. 3A.

Then, as shown in FIG. 2, the power semiconductor module 1 is mounted on the socket substrate 10. In this case, as described above, the power semiconductor module 1 may be mounted on the socket substrate 10 by the soldering.

Next, the socket substrate 10 having the power semiconductor module 1 mounted thereon is coupled to the jig substrate 20. In this case, the socket substrate 10 and the jig substrate 20 may be connected to each other by the connector 18 coupling.

In addition, the jig substrate 20 is coupled to the main substrate 30 while being disposed within the case 40. The jig substrate 20 and the main substrate 30 may also be connected to each other by the connector 18 coupling. Further, in this process, the temperature measuring part 50 is electrically connected to the controlling part 70.

When preparation to test the power semiconductor module 1 is completed through the above-mentioned process, the test is performed.

The test may be performed by applying various voltages to the power semiconductor module 1 through the controlling part 70, measuring heat generated in the power semiconductor module through the temperature measuring part 50, and detecting a change of state in the power semiconductor module 1. In this case, the test may also be performed while cooling the power semiconductor module 1 through the cooling part 60 if necessary.

In addition, in this process, the controlling part 70 may use one temperature sensor 55 or plural temperature sensors 55 according to the number of switching devices 2 to be tested. That is, in the case of testing only one switching device 2, the controlling part 70 may use only one temperature sensor 55 disposed so as to be the most adjacent to the corresponding switching device 2.

Further, also in the case of testing two or three switching devices 2 together, the controlling part 70 may measure temperatures using two temperature sensors 55 adjacent to the corresponding switching devices 2 and then use an average value of the measured temperatures. Likewise, in the case of testing all of the six switching devices 2, the controlling part 70 may measure temperatures using all of the three temperature sensors 55 and then use an average value of the measured temperatures.

Meanwhile, it is preferable that the power semiconductor module 1 is tested by directly measuring a temperature of the switching device 2. However, since the switching device 2 is generally sealed by a molding material, it is substantially difficult to directly measure the temperature of the switching device 2.

Therefore, in the method of testing a power semiconductor module according to the present embodiment, the power semiconductor module 1 is tested using a surface temperature (T_{C}) corresponding to a junction temperature (T_{J}), which is a threshold temperature of the switching device 2. That is, after a maximum surface temperature (T_{C}) corresponding to the junction temperature (T_{J}) is estimated, the test may be performed in the estimated maximum surface temperature (T_{C}).

Here, the surface temperature (T_{C}) means a temperature measured on an outer surface of the power semiconductor module 1 and may be arithmetically estimated or be measured by the above-mentioned temperature sensors 55.

A relationship between the junction temperature and the surface temperature may be recognized by the following Equation 1 that has been generally known.

T_{J}−T_{C}=NP_{D}×Rₜₕ(J_{C}) (Equation 1)

Where T_{J} indicates a junction temperature, T_{C} indicates a surface temperature (case temperature), and Rₜₕ(J_{C}) indicates a thermal resistance value of the power semiconductor module 1. In addition, P_{D} means power applied to the switching device 2 and N means the number of switching devices to which the power is applied.

In addition, P_{D} may be defined by the following Equation 2.

P_{D}=I_{CC}×DUTY RATE×V_{CC} (Equation 2)

Here, I_{CC} means a current applied to the switching device, and V_{CC} means a voltage applied to the switching device, and DUTY RATE means a % value maintained in a HIGH state in one period.

The following Table 2 shows an example of estimating a surface temperature (T_{C}) of the power semiconductor module 1 under a high temperature condition and a low temperature condition when the junction temperature (T_{J}) is set to 150° C.

TABLE 2

| | Low | High | | | | | | | | |
|---|---|---|---|---|---|---|---|---|---|---|
| | temperature | temperature | | | | | | Number of | | |
| | condition | condition | T_{J} | | | duty | | switching | | |
| No | (° C.) | (° C.) | (° C.) | Rₜₕ | I_{CC} | rate | V_{CC} | device | P_{D} | P_{D} × Rₜₕ |
| 1 | 30 | 147 | 150 | 3.3 | 2 | 0.5 | 1 | 1 | 1 | 3.3 |
| 2 | 30 | 143 | 150 | 3.3 | 2 | 0.5 | 1 | 2 | 2 | 6.6 |
| 3 | 30 | 130 | 150 | 3.3 | 2 | 0.5 | 1 | 6 | 6 | 19.8 |
| 4 | 30 | 142 | 150 | 3.3 | 4 | 0.5 | 1.2 | 1 | 2.4 | 7.9 |
| 5 | 30 | 134 | 150 | 3.3 | 4 | 0.5 | 1.2 | 2 | 4.8 | 15.8 |
| 6 | 30 | 136 | 150 | 3.3 | 6 | 0.5 | 1.4 | 1 | 4.2 | 13.9 |

Describing an example No. 1 in which measurement is performed for one switching device with reference to Table 2, in the case in which the junction temperature (T_{J}) is 150° C., a maximum surface temperature (T_{C}) corresponding to the junction temperature (T_{J}) should be measured to be 147° C. In this case, the maximum surface temperature (T_{C}) may be obtained by the above-mentioned Equation 1 and Equation 2. That is, since T_{J} is 150° C. and NP_{D}×Rₜₕ (J_{C}) is 3.3, the maximum surface temperature (T_{C}) may be obtained by calculation of 150−3.3≈147. Here, since values obtained by performing the calculation while omitting the number after a decimal point are shown in Table 2, a slight error may be present.

Therefore, a worker may control a value of the current (I_{CC}) applied to the switching device to set a maximum value of I_{CC} so that the surface temperature T_{C} of the switching device rises only up to 147° C. In addition, the worker may perform the test on the corresponding power semiconductor module 1 while changing a temperature between the low temperature condition (30° C.) and the high temperature condition (147° C.).

Likewise, referring to an example No. 3 in which measurement is performed for six switching devices, the maximum surface temperature (T_{C}) should be measured to be 130° C. in order for the junction temperature (T_{J}) to be 150° C. Also in this case, the maximum surface temperature (T_{C}) may be obtained by calculation of 150−18.8≈130. Therefore, the worker may control a value of the current (I_{CC}) applied to the switching device to set a maximum value of I_{CC} so that the surface temperature T_{C} of the switching device rises only up to 120° C. In addition, the worker may perform the test on the corresponding power semiconductor module 1 while changing a temperature between the low temperature condition (30° C.) and the high temperature condition (130° C.).

As described above, in the method of testing a power semiconductor module according to the present embodiment, the surface temperatures corresponding to the junction temperatures of the switching devices may be estimated and various characteristics at the junction temperatures may be tested while applying various types of voltages to the power semiconductor module using the estimated surface temperature.

The apparatus and method of testing a semiconductor module according to the present invention as described above are not limited to the above-mentioned embodiment, but may be variously applied if necessary. Further, although the power semiconductor module has been described by way of example in the above-mentioned embodiment, the present invention is not limited thereto, but may be widely applied to an apparatus of measuring heat generation.

As set forth above, with the apparatus and method of testing a semiconductor module according to the embodiment of the present invention, the six switching devices provided in the power semiconductor module may be simultaneously or independently tested. In addition, the jig substrate and the socket substrate may be configured to be detachable from the main substrate.

Therefore, the semiconductor module including the plurality of switching devices may be tested by various methods.

Further, after several kinds of power semiconductor modules are coupled to the socket substrate and the jig substrate the test may be performed while replacing only the jig substrate. As a result, the test may be easily performed.

While the present invention has been shown and described in connection with the embodiments, it will be apparent to those skilled in the art that modifications and variations can be made without departing from the spirit and scope of the invention as defined by the appended claims.

What is claimed is:

1. An apparatus for testing a semiconductor module comprising:
a main substrate disposed within a case;
a jig substrate detachably coupled to the main substrate; and
a socket substrate detachably coupled to the jig substrate and having the semiconductor module mounted thereon.

2. The apparatus for testing a semiconductor module of claim 1, wherein the main substrate and the jig substrate are electrically and physically coupled to each other by connector coupling.

3. The apparatus for testing a semiconductor module of claim 1, wherein the jig substrate and the socket substrate are electrically and physically coupled to each other by connector coupling.

4. The apparatus for testing a semiconductor module of claim 1, wherein the semiconductor module is soldered to and mounted on the socket substrate by a conductive solder.

5. The apparatus for testing a semiconductor module of claim 1, wherein the jig substrate is coupled to the main substrate so as to be perpendicular to the main substrate.

6. The apparatus for testing a semiconductor module of claim 1, further comprising a cooling part disposed within the case and cooling the semiconductor module.

7. The apparatus for testing a semiconductor module of claim 1, further comprising a temperature measuring part coupled to the semiconductor module and sensing a temperature change in the semiconductor module.

8. The apparatus for testing a semiconductor module of claim 7, further comprising a controlling part electrically connected to the main substrate and the temperature measuring part, selectively applying power to the semiconductor module through the main substrate, and measuring the temperature change of the semiconductor module through the temperature measuring part.

9. The apparatus for testing a semiconductor module of claim 7, wherein the temperature measuring part includes:
a fixing jig coupled to an outer surface of the semiconductor module while contacting the outer surface of the semiconductor module; and
at least one temperature sensor coupled to the fixing jig and sensing a temperature of the semiconductor module.

10. The apparatus for testing a semiconductor module of claim 9, wherein the fixing jig has an insertion groove formed in one surface thereof contacting the semiconductor module, and the temperature sensor is inserted into the insertion groove to contact the outer surface of the semiconductor module.

11. The apparatus for testing a semiconductor module of claim 9, wherein the semiconductor module includes a plurality of switching devices, and a plurality of temperature sensors are disposed in positions corresponding to those of the switching devices, respectively.

12. The apparatus for testing a semiconductor module of claim 9, wherein the semiconductor module includes six switching devices, and three temperature sensors are disposed in positions corresponding to spaces between the switching devices.

13. A method of testing a semiconductor module comprising:
mounting a semiconductor module on a socket substrate;
coupling the socket substrate to a jig substrate;
coupling the jig substrate to a main substrate disposed within a case; and
testing the semiconductor module by applying a voltage to the semiconductor module.

14. The method of testing a semiconductor module of claim 13, wherein the coupling of the jig substrate to the main substrate includes coupling the jig substrate to the main substrate so as to be perpendicular to the main substrate.

15. The method of testing a semiconductor module of claim 13, further comprising, before the mounting of the semiconductor module on the socket substrate, coupling a temperature measuring part to the semiconductor module.

16. The method of testing a semiconductor module of claim 15, wherein the testing of the semiconductor module includes measuring a change of state in the semiconductor module according to a change in the applied voltage.

17. The method of testing a semiconductor module of claim 15, wherein the testing of the semiconductor module includes:
estimating surface temperatures corresponding to junction temperatures of switching devices provided in the semiconductor module; and
applying the voltage to the semiconductor module based on the estimated surface temperatures.

18. The method of testing a semiconductor module of claim 17, wherein the estimating of the surface temperatures includes:
measuring temperatures using a plurality of temperature sensors disposed in the semiconductor module so as to be spaced apart from each other; and
estimating the surface temperatures of the semiconductor modules using an average value of the measured temperature values.
